(19) United States
(12) Patent Application Publication
(10) Pub. No.: US 2001/0022118 A1
(43) Pub. Date: Sep. 20, 2001

(54) tightening nut for a collect

(75) Inventor: Martin Zollmann, Sonnenbuehl, DE (US)

Correspondence Address: Striker Striker & Stenby, 103 East Neck Road, Huntington, NY, 11743, US

(73) Assignee: Z0LLMANN

(21) Appl. No.: 09/497,580

(22) Filed: Feb. 3, 2000

(30) Foreign Application Priority Data
May 6, 1999 (DE) 299 07 998.8

(51) Int. Cl. B25B 13/48

(52) U.S. Cl. 81/176.15

(57) ABSTRACT

A tightening nut for a collet, which is tightenable by a key, has a nut body with two end sides, a plurality of depressions provided on at least one of the end sides of the nut body for receiving correspondingly shaped pins arranged on the key, the depressions being formed as grooves with a dovetail-shaped cross-section, so that pins of the key which have a shape corresponding to the dovetail-shaped cross-section of the grooves are insertable in the grooves, the grooves having an opening width adapted to be greater than a maximum width of the pins.

### BACKGROUND OF THE INVENTION

The present invention relates generally to a tightening nut for collets.

More particularly, it relates to a tightening nut for a collet which is tightenable by a key, wherein the tightening nut or one of its end sides is provided with depressions for receiving corresponding shaped pins arranged on the key.

Tightening nuts of the above mentioned general type are known. The associated key is laterally placed on the tightening nut, whereby the nut can have a relatively small axial dimension. Tightening nuts with circular depressions are relatively widely utilized. The pins with circular cross-section of an associated key are insertable in the circular depressions.

The German patent document DE GM 296 08 677.0 also discloses a tightening nut with depressions formed as elongated holes. The correspondingly shaped pins of a key are insertable in the elongated holes. When compared with the tightening nuts having circular depressions, these tightening nuts and the associated key have a higher stability against the forces which occur during tightening. All known tightening nuts have however the disadvantage, that the key during the tensioning process can slide out of the depressions, and thereby a not insignificant injury damage can be caused.

### SUMMARY OF THE INVENTION

Accordingly, it is an object of the present invention to provide a tensioning nut of the above mentioned general type, which avoids the disadvantages of the prior art.

More particularly, it is an object of present invention to provide a tightening nut of the above mentioned general type, which is formed so that a sliding out of the key during the tensioning process is no longer possible.

In keeping with these objects and with others which will become apparent hereinafter, one feature of present invention resides, briefly stated, in a tightening nut of the above mentioned general type, in which the depressions are formed as grooves having a dovetail-shaped cross-section, and the pins of the key have a dovetail-shaped cross-section which corresponds to the cross-section of the grooves, wherein the maximum width of the pins is smaller than the opening width of the grooves.

When the tightening process is performed or in otherwords the key is turned, the dovetail-shaped pins of the key slide until the abutment against the groove edges, so that an axial pulling out of the key in this position is no longer possible. Thereby also an unauthorized sliding out of the key on the tightening nut is excluded. Simultaneously the pins have a sufficient stability so as not to be sheared off during the tightening process.

The grooves can be for example at least substantially oriented transversely to the direction of force action of the key. Thereby the dovetail-shaped groove edges form a both-side abutment for the correspondingly shaped pins of the key so that the sliding out securing for the key in both rotary directions of the tightening nut is provided.

The tightening nut can be provided preferably with four grooves which are uniformly distributed over a circle on its end surface. Thereby the grooves and also the pins of the key are orderly spaced from one another, and an optimal force transmission from the key to the tightening nut is guaranteed.

The tightening nut can have a dimension in an axial direction of less than 1 cm. This is advantageous for the space consumption of the tool. Moreover, it is possible to select the outer diameter of the key so that the tightening nut is turnable completely in a tool hollow shaft. It is not necessary that it laterally projects beyond the shaft, for engagement by the key.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a plan view of one end side of a tightening nut in accordance with the present invention;

FIG. 2 is a central longitudinal section of the inventive tightening nut of FIG. 1;

FIG. 3 is a plan view of a tightening key used with the inventive tightening nut; and

FIG. 4 is a side view of the collet of tightening key of FIG. 3.

### DESCRIPTION OF PREFERRED EMBODIMENTS

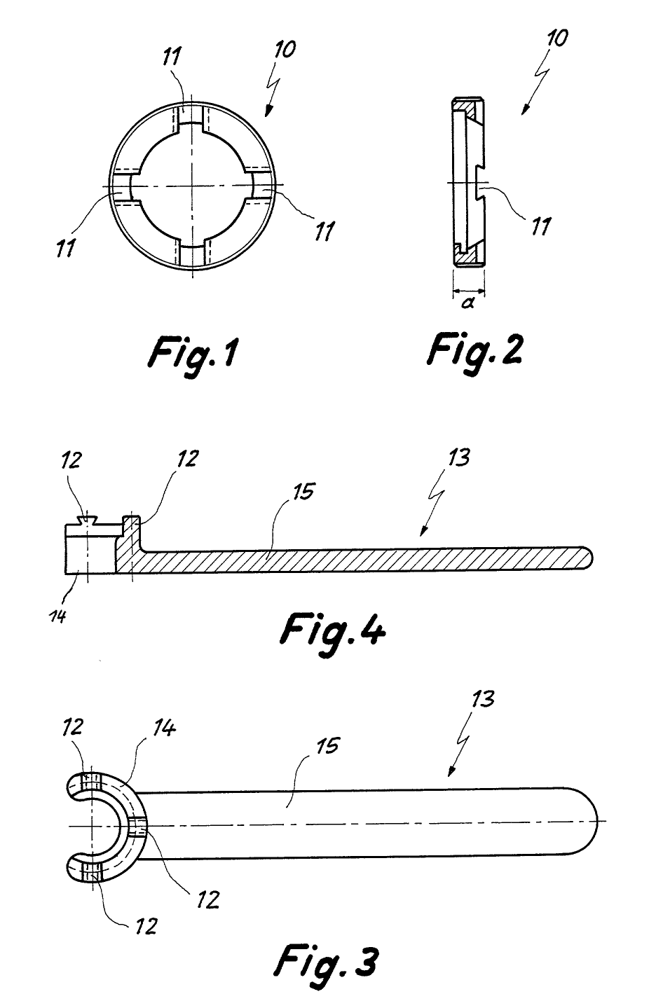

A tightening nut in accordance with the present invention is identified in FIG. 1 with reference numeral 10. The inventive tightening nut has four grooves 11 which are uniformly distributed over its periphery. The grooves 11 have a dovetail-shaped cross-section as can be seen in particular in FIG. 2. FIG. 2 clearly shows that the tightening nut 10 has a relatively small axial dimension “a”.

FIGS. 3 and 4 show a tightening key which is identified as a whole with reference numeral 13 and is used for tightening of the tightening nut 10. The key 13 is provided with pins 12 which have a shape corresponding to the dovetail-shaped grooves 11. The pins 13 are insertable in the grooves 11. The pins 12 are formed on a head 14. The head 14 of the key 13 is semi-circular and extends perpendicular to a handle 15 of the key 13.

The key 13 can be placed thereby laterally on the tightening nut 10 as shown in FIGS. 1 and 2. The pins 12 have a dovetail-shaped cross-section which corresponds to the diameter of the grooves 11 of the tightening nut 10. However, the pins 12 have the maximum width which is greater than the opening width of the grooves 11. The pins 12 are easily insertable into the grooves 11. The pins 12 are sufficiently stable to avoid a sheering-off.

The tightening nut 10 and the key 13 can be formed as cast parts. Thereby their stability is additionally increased. The dovetail-shaped pins 12 which are inserted in the dovetail-shaped grooves 11 produce a dovetail-shape connection between the key 13 and the tightening nut 10, which prevents an unauthorized sliding out of the key 13 during tightening process. The grooves 11 are oriented radially, or in other words perpendicular to the direction of force application of the key 13.

It will be understood that each of the elements described above, or two or more together, may also find a useful application in other types of constructions differing from the types described above.

While the invention has been illustrated and described as embodied in tightening nut for a key, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A tightening nut for a collet, which is tightenable by a key, the tightening nuts having a nut body with two end sides; a plurality of depressions provided on at least one of said end sides of said nut body for receiving correspondingly shaped pins arranged on the key, said depressions being formed as grooves with a dovetail-shaped cross-section, so that pins of the key which have a shape corresponding to said dovetail-shaped cross-section of said grooves are insertable in said grooves, said grooves having an opening width adapted to be greater than a maximum width of the pins.

2. A tightening nut as defined in claim 1, wherein said grooves are oriented at least substantially transversely to a force application direction of said key.

3. A tightening nut as defined in claim 1, wherein said body is provided with four said grooves which are arranged on a circle on said at least one end surface.

4. A tightening nut as defined in claim 1, wherein said nut body has a dimension in an axial direction which is less than 1 cm.

5. A tightening device for a collet, comprising a tightening nut having a nut body with two end sides and a plurality of depressions provided on one of said end sides, said depressions being formed as grooves having a dovetail-shaped cross-section; and a key for tightening said nut and having a plurality of pins with a dove-tail shaped cross-section corresponding to said dovetail-shaped cross-section of said grooves of said tightening nut and insertable into said grooves, said pins having a maximum width which is smaller than an opening width of said grooves.
